(19) United States
(12) Patent Application Publication
(10) Pub. No.: US 2004/0200547 A1
(43) Pub. Date: Oct. 14, 2004

(54) Method for producing compatible ends on profile wrapped or laminated lineal Zcomponents requiring consistant or continuous color, and / or mechanical properties on exposed areas

(76) Inventor: Michael J. Entenmann, Rib Lake, WI (US)

Correspondence Address: Michael J. Entenmann, W 1260 County Highway M, Rib Lake, WI, 54470, US

(21) Appl. No.: 10/408,851

(22) Filed: Apr. 8, 2003

(51) Int. Cl. B27D 1/00; B27G 11/00

(52) U.S. Cl. 144/346

(57) ABSTRACT

A method for producing lineal components with compatible ends on profile wrapped or laminated components. This method consists of inserting similar or dissimilar materials into a substrate, located in such a position that after applying a thin veneer, foil, paper, metal, plastic, composite, or other material on the outside of the product, the product can be machined by conventional or non conventional methods. The surfaces exposed through this machining process would not appear as an exposed piece of the substrate material but as a material that is similar in appearance to the thin veneer, foil, paper, metal, plastic, composite or other material thus providing the appearance of a solid or continuous component. This method of manufacture can also be useful to provide protection of surfaces that have been machined, similar to the protection afforded by the thin veneer, foil, paper, metal, plastic, composite or other material. Such protection could include, but is not limited to moisture proofing, weatherproofing, waterproofing, sunlight resistance and chemical resistance, or to provide a surface with similar or compatible properties to the thin veneer, foil, paper, metal, plastic, composite or other material for the adhesion of applied coatings and other products.

### FIELD OF THE INVENTION

This invention relates to profile wrapped or laminated methods and the products produced in general and to methods for producing profile wrapped or laminated lineal components with ends, or surfaces exposed through machining and/or other manufacturing processes and the products thus produced in particular.

### BACKGROUND OF THE INVENTION

Lineal components are used for producing products such as kitchen and bath cabinets, windows and doors, exterior house trim, exterior siding and the like. Traditionally these products have been made of wood. In the last 40 years or so many different products have been developed to simulate the products previously made of wood. Some of these products are, steel, aluminum, or vinyl siding, vinyl, fiberglass, aluminum, steel or aluminum clad windows and doors, and plastic covered cabinets. Engineered or composite board products have also been developed for these products.

The principal reason for the development of these alternate products is the reduced maintenance requirements these products afford. By substituting these products for wood components, periodic scraping and painting has been eliminated over the life of the product.

Wood or wood composites would return as the favored material if the periodic maintenance could be eliminated. Wood is a superior product in regards to such factors as dimensional stability, thermal conductivity, electrical resistance, it's ability to form to shapes, and ease of profiling to name a few. It also has appeal as a traditional material, it is solid when installed, it is dimensionally stable, it is resistant to dents and it does not crack when exposed to minor stress when it is cold.

It is common in the art to laminate a thin film over a core material such as wood, plastic, metal or composite material as well as other materials. For lineal components this is done through the process known as profile wrapping or profile laminating.

Profile wrapping consists of applying glue to the surface of either the laminate material or the substrate and then applying the laminate to the substrate by using a series of rollers or other means to form the laminate to the substrate. Profile wrapping has the advantage of being able to laminate complex profiles in an efficient manner. Profile wrapping can not cover the ends of the product, as it is only possible to cover part or all of the lineal profile.

Wrapping the thin film over a substrate or core material protects the face of the product thus covered, giving it the desirable properties of the face or laminate material. At the same time it retains the desirable characteristics of the core material or substrate.

Films used to cover a substrate or core material can include but are not limited to vinyl and other plastics, paper and composite papers, metal foils, wood or reconstituted veneers, and various engineered composites. They offer the advantages of improved appearance, color, UV and/or sunlight resistance, water resistance, air and moisture impermeability and other mechanical factors useful to the design of many products. Materials are available that will not degrade for generations under severe outdoor exposure.

Core materials or substrates used may include but are not limited to plywood, particleboard, fiberboard, chipboard, wafer-board, OSB, LVL, and other engineered wood products, lower grades, less expensive species or mechanically more desirable wood or wood products, plastics, foams, metals, composite materials, papers and others and combinations of any or all of these materials.

Profile wrapping or profile laminating can not cover all the exposed surfaces of the product and must leave at least 2 surfaces exposed and/or uncovered. Furthermore, none of these methods provides for the desirable ability to machine through the applied surface without adversely affecting the appearance and or durability of the product. When it has been desirable to have a product with machined ends, or other exposed surfaces, it has thus been necessary to use more expensive solid materials.

Prior art has not addressed the need to produce these laminated parts with exposed ends or machined areas that are of a suitable material when these areas are exposed. For reasons of aesthetics or mechanical properties or other concerns, it is often necessary to have machined or otherwise exposed areas of profile wrapped or profile laminated products that must be of a suitable material in accordance with the design and end use of the part.

It is therefore an object of this invention to create a means by which profile wrapped or profile laminated parts can have the ends of the substrate exposed in areas that are critical to the product design, with an appearance or property that is compatible to the laminate material, either in appearance or mechanical properties.

### SUMMARY OF THE INVENTION

I claim a method of producing a laminated product that overcomes the problems as mentioned and discussed above. A product that is thus produced will have the appearance and/or mechanical properties of being produced from a solid material of the desired type in any area where it is deemed necessary or appropriate to do so.

The product produced will have 1 or more laminate overlays of veneer, plastic, paper, metal, composite material or other material suitable for a laminate that is appropriate to the design of the end product. This laminate will be applied to a substrate with adhesive or any other method appropriate to the product design.

The substrate may be of any material appropriate to the product design, including but not limited to, particleboard, fiberboard, chipboard, oriented strand board, plywood, wood or wood composites, plastic including foamed products, metal, composites or any combination of such materials as required by the design of the product.

In respect to this invention, the substrate will have areas of the substrate machined out to accept filler material or other types of material to fill the affected areas to make the substrate a solid piece of core material for further processing in accordance with methods commonly used in the art. The filler material can be of any material including but not limited to, wood or wood composite, plastic, metal, composites, or liquid or semi liquid materials that can be poured into or otherwise applied to the machined areas of the substrate. The filler material may be applied to the end or ends, face or faces, or any combination of ends and faces, of the substrate material by these same means.

After being suitably prepared for laminating, the substrate will have the laminate applied by any means common in the art including but not limited to the methods mentioned above.

The part or panel thus assembled will then be ready to be machined, which is part of the process covered in this invention. By machining through the laminate into the filler material previously applied to the ends of the substrate as described above, a product can thus be produced with all the appearance and mechanical capabilities of a part produced from a solid material, in the area that is laminated and in the area that is machined.

The material used as a filler material need not be the same material as the covering laminate but can be any suitable material that will provide the desired effect of the finished product. Such material may be chosen not only for it's similar characteristics to the laminate material but may also be chosen for complimentary or contrasting appearance, of for other desirable mechanical characteristics as required by the design of the end product.

Reasons to choose dissimilar filler material are not limited to but may be for contrasting color, water, weather, light or chemical resistance, improved mechanical strength in a required area, or improved ability to accept fasteners or adhesives to name a few.

### DESCRIPTION OF THE DRAWINGS

The drawings show the progression of the components into a desirable part using the claims described in this patent. These are representations of one of the many different ways this technology can be used. This is not meant to limit the scope of this patent but is provided only for clarity.

FIGS. 1 through 6 show a progression of steps for using this method to produce lineal components such as would be used to produce a window or door sash or frame or other similar product with exposed ends and face or faces.

FIG. 1 shows a lineal piece that has been machine to receive filler strips in 4 locations. 1 end is coped, 1 end tenoned, the center has a dado machined across the top face and there is a hole drilled through the part from the side in the middle of the part also. The part is shown as a piece of wood but can be of any suitable material.

FIG. 2 shows the same part with fillers in the machined areas. In this example the fillers are represented as being of a solid material such as plastic, but can be of any suitable material according to the end use of the part or parts produced.

FIG. 3 shows the part with the filler strips in it after it has been profile machined to a lineal shape, such as would be done with moldings, window and door components and other such parts.

FIG. 4 shows the profiled part with a layer of laminate film applied over the top and portions of the 2 sides. In this example the material shown would be a solid film of plastic, paper, metal or other suitable material but other substances may also be used depending on the requirements of the finished part.

FIG. 5 shows an enlarged end view of the profiled part with a film wrapped around 3 sides, with an exposed end piece of a compatible material as well as the exposed end of the substrate material where the end does not need to be of a compatible material to the film that wrapped the 3 sides of the profile. In this example the part shows an area that has been tenoned to form ½ of a cope and tenon joint.

FIG. 6 shows a representation of the laminated profile after it has been cut into 2 pieces with different types of end machining being represented on each piece. 1 part has the ends coped and the other piece has the ends tenoned as would be done with window or door sash components, and furniture, cabinet and other such useful products.

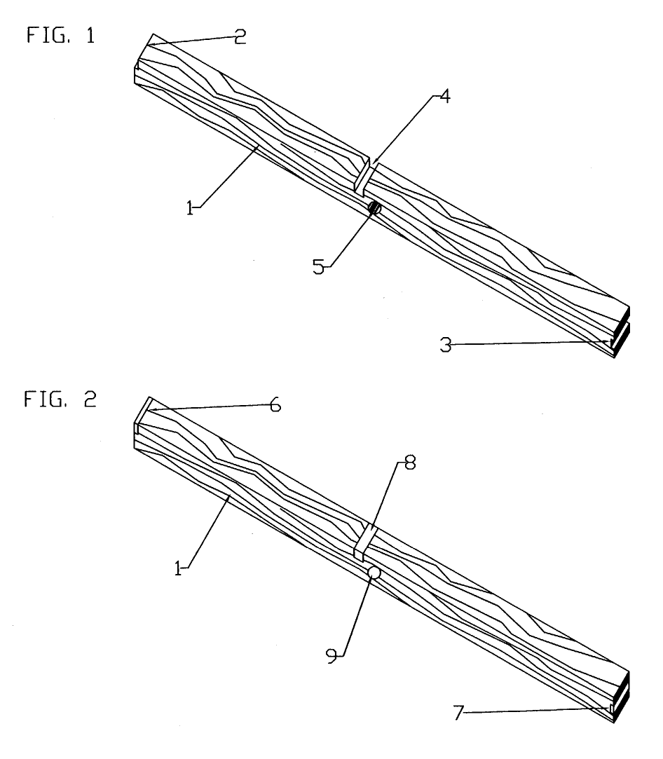

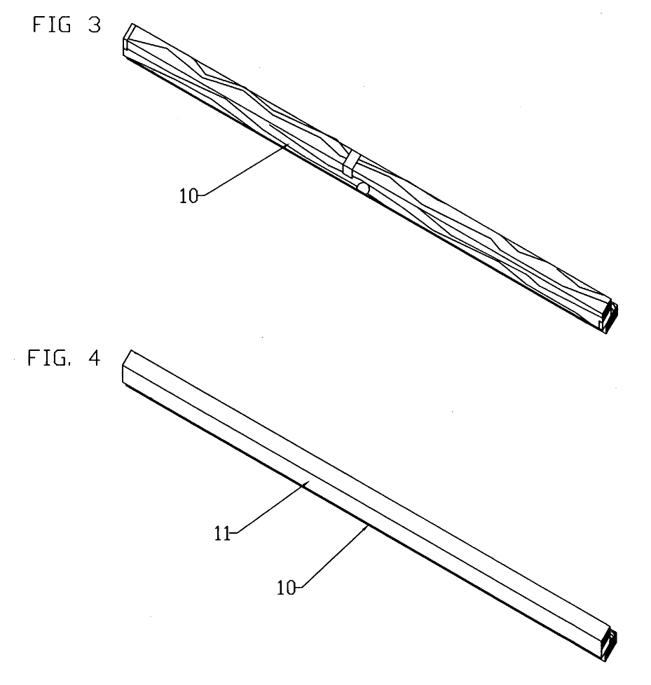

The parts shown in FIGS. 1 through 6 could represent window components or other such product. It can then be seen that if filler strips of a suitable material and color were used and the part was then laminated with a material that matched the appearance of the filler strips the resulting part, after being machined on the ends and assembled, would produce a finished product that would have a surface with any desirable effects that the applied material could provide, such as but not limited to, color, weather resistance, moisture or water resistance, sunlight resistance, chemical resistance, abrasion resistance and the like.

### DETAILED DESCRIPTION OF THE INVENTION

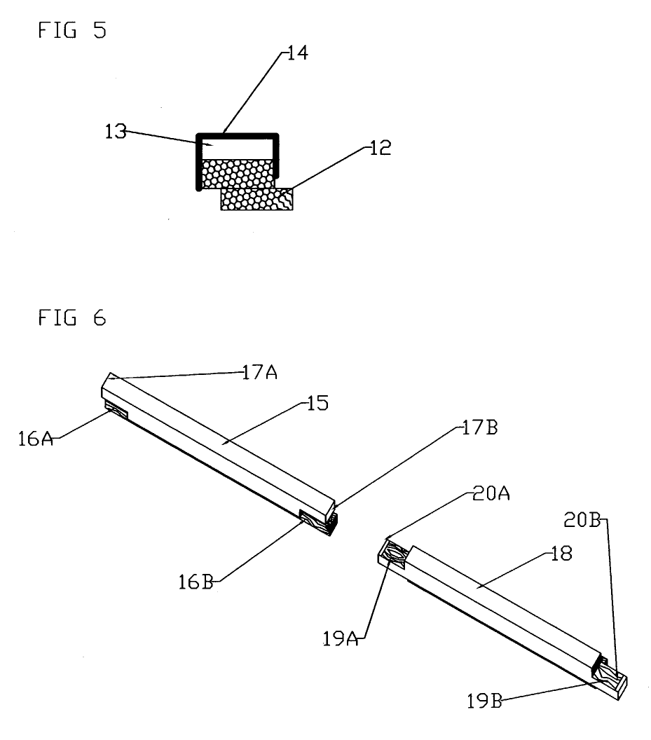

In referring to the drawings, FIG. 6 shows a representative example of finished products that can be produced using the methods and procedures claimed in this invention. In this case a window or door sash component is shown. This is only a representative product using this invention and is not meant to limit the scope of this invention in any way, but is useful to understand the procedures for producing products covered by this invention and the type of products that can thus be produced.

As shown in the FIG. 1, a raw piece of an acceptable substrate 1, in this view shown as a piece of wood, has one end machined with an acceptable dado 2, and the other end machined with an acceptable cope 3. At the top center of the piece a dado 4 has been machined and a through hole 5 has been drilled in the side.

Fill material is glued or otherwise adhered to the substrate as shown FIG. 2. The dado 6, cope 7, dado 8 and bore 9 are filled with this fill material. The raw substrate is then machined to the shape of the desired profile 10 by any of the various means common in the art.

This machined profile 10, is then laminated with a thin film 11, by means of profile wrapping, laminating or any other method common in the art.

In the end view in FIG. 5 it can be seen that the film 14, is laminated to the core stock 12, and fill material 13, of the profiled part. In this respect, if the film 14, and the fill material 13, are of a similar or compatible material and color, the result would be a component that has the appearance of a solid color component on what would be the exterior surface. If the film 14, and the fill material 13, are of material that has the proper mechanical properties, this component could also be maintenance free, and/or have an extended usable life expectancy. Furthermore the resultant component would not require any finishing work or procedures after it is installed.

If the end of the lineal profile shown in FIG. 4 is machined as a cope 16A, as shown in FIG. 6, at the location of the dado fill piece 6, the end of the cope 16A thus exposed would have the desirable properties of the fill piece 6, 17A.

If the lineal profile shown in FIG. 4 is cut at the location that exposes the end of the dado fill piece 8, as shown in FIG. 6 and then machined as a cope 16B, the end of the cope 16B thus exposed would have the desirable properties of the fill piece 8, 17B.

If the lineal profile shown in FIG. 4 is cut through the approximate middle of the bore fill piece 9, as shown in FIG. 6, and then machined as a tenon 19A, the end of the tenon 19A thus exposed would have the desirable properties of the fill piece 9, 20A.

If the end of the lineal profile shown in FIG. 4 is machined as a tenon 19B, at the location of the tenon fill piece 7, as shown in FIG. 6, the end of the tenon 19B thus exposed would have the desirable properties of the fill piece 7, 20B.

FIG. 6 thus depicts lineal components which have the desirable effect of exposed ends that are similar in appearance and mechanical properties to the laminate material applied to the face of the core material.

Products produced in this manner would be useful for the production and manufacture of furniture, cabinet, millwork and other components where it is desirable for a component to appear to be of a solid material at all exposed surfaces.

This method can also be used if it is desirable for a product to have specific mechanical properties as well as visual properties. Instances where this may be required could be but are not limited to furniture and cabinets that require chemical or water resistance in their use such as laboratory or bathroom products, or where cleaning and sterility is necessary such as hospital furniture and such.

This method also provides the ability to produce millwork components such as exterior trim and window or door components that can be produced of materials that would be desirable for mechanical properties or cost considerations, but that have a laminate applied on the exterior face that would provide a colored and weatherproof face with desirable UV resistance and other mechanical properties. Such a product would provide an economical means of manufacturing traditional products with an exterior surface that could be maintenance free.

Also a product that could be produced using this method would be siding strips for structures. Using the methods described above, solid siding boards could be produced using a film with weather, water and sunlight resistance to provide the protective colored surface. Waterproof fillers could be installed at each end of the boards before they are profile wrapped. This would produce a solid board that is totally weatherproof, with an inexpensive core material such as foamed plastics, particleboard, OSB or other composite products, laminated or low grade wood products, cement board, and the like.

It is thus shown that this invention fills a presently unfilled need and provides an economical means of producing useful components for a variety of products.

What is claimed is:

1 A method of manufacturing a lineal component, consisting of a laminate material applied to a core material or substrate that can be machined to produce a desirable product in which the exposed surfaces will be of the same or complimentary color and/or with an otherwise desirable appearance or mechanical property or properties. This method of manufacturing is comprised of all of the following steps except that step B may be used with or without step C, or step C may be used with or without step B.
A} Producing or providing a substrate consisting of an acceptable material for the core of the product, such as but not limited to, low grade wood or wood product, particleboard, fiberboard of an acceptable density, plywood, plastic, foam, metal, composite or engineered material or other material suitable for a core.
B} Machining out pockets in the end of the substrate, of a size and shape as required to accept the installation or pouring of the filler strip or strips, or filler material. Said pocket may be on the end or ends of the substrate, or on any face of the substrate, in any location, as required by the final use or design of the end product.
C} Machining the end or ends or face or faces or any end and face combination, of the substrate to provide an appropriate surface to adhere the filler strip or filler material to these ends or faces, without the necessity of machining a pocket, whenever appropriate.
D} Machining, extruding, casting, stamping, molding or otherwise producing plugs, strips or other shapes to fill the pockets machined out in step B, or casting, pouring or otherwise applying a liquid or semi-liquid material in the pockets machined out on step B, or other method for filling the pocket with a suitable material, for the purpose of producing fillers for the pockets described in this patent.
E} Gluing the plugs, strips or shapes produced in step D, or pouring an appropriate filler material such as epoxy or other castable materials, into the pocket or pockets produced in step B, or on to the end or ends, or face or faces of the substrate. Said strips, shapes or liquid material may be glued or poured between individual pieces of substrate, to produce a lineal component of extended length, for more effective and or efficient manufacture. The lineal component may be used as a single component or may be cut down into individual components as required to produce the final product or products.
F} Machining the substrate thus produced so that it is of a profile that can accept the laminating, profile wrapping, pressing or other application method of the coating material.
G} Applying the thin veneer, foil, paper, metal, plastic, composite or other material to the substrate after the filler material has been applied and the thus formed substrate has been machined.
H} Machining through or along the thin veneer, foil, paper, metal, plastic, composite or other material thus exposing the filler material to produce the desired visual, or mechanical result.

2: The process of machining a pocket or pockets into the end or ends of a substrate for the express purpose of filling the pockets with a material that will be exposed after laminating as describe in claim 1.

3: The process of manufacturing a filler to fill a pocket as described in claim 1, and claim 2, including applying the filler into the pocket, as described in claim 1, for the purpose of providing a desirable surface material that can be exposed by machining after laminating as described in claim 1

4: The process of manufacturing a filler to glue or otherwise adhere between 2 pieces of material to provide a lineal component as described in claim 1, for the purpose of cutting into more than 1 component after the processes of profiling and laminating as described in claim 1.

5: The process of drilling or otherwise machining through a lineal component and filling the resultant hole with a filler material as described in claim 1, to provide an end surface or surfaces, that will be compatible with an applied laminate material when the lineal component is cut through at the point that exposes this filler material

6: The process of profiling or otherwise machining the lineal component produced in claim 3 or claim 4 or claim 5 or any combination thereof, to prepare it for the process of profile wrapping or otherwise laminating 2 or more faces or surfaces.

7: The process of profile wrapping or otherwise laminating a film or other material over 2 or more faces or surfaces of the substrate as produced in claim 6, for the purpose of producing a lineal component that can be machined into 1 or more components with ends that are visually or mechanically compatible, or otherwise useful.

8: The process of machining through a laminate material, thus exposing the filler material described in claim 1 and claim 3 and claim 4 and claim 5 or any combination thereof, to produce a useful component in which the selected surfaces will be of a consistent appearance. Machining through the surface material or laminate may also include machining into or through the applied filler material, to comply with, or as required by, the design of the product produced.

9: The process of machining through a laminate material, thus exposing the filler material described in claim 1 and claim 3 and claim 4 and claim 5 or any combination thereof, to produce a useful component with an area thus exposed that would have a dissimilar or contrasting appearance as required by the design of the final product. Machining through the surface material or laminate may also include machining into or through the applied filler material, to comply with, or as required by, the design of the product produced.

10: The process of machining through a laminate material, thus exposing the filler material described in claim 1 and claim 3 and claim 4 and claim 5 or any combination thereof, to produce a useful component with an exposed surface that has mechanical or chemical properties that are useful or required by the design of the end product, but which would not be possible if the substrate material were exposed by the machining process. Machining through the surface material or laminate may also include machining into or through the applied filler material, to comply with, or as required by, the design of the product produced.
